(19) United States
(12) Patent Application Publication
(10) Pub. No.: US 2007/0217068 A1
(43) Pub. Date: Sep. 20, 2007

(54) Method of producing magnetic head and magnetic head

(75) Inventors: Yuko Miyake, Kawasaki (JP); Masaaki Matsuoka, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/544,387

(22) Filed: Oct. 6, 2006

(30) Foreign Application Priority Data
Mar. 16, 2006 (JP) 2006-73322

(51) Int. Cl. G11B 5/147; G11B 5/127

(52) U.S. Cl. 360/126; 29/603.01

(57) ABSTRACT

The a method of producing a magnetic head is capable of stabilizing deposition rate of a plated magnetic film forming a magnetic pole of a write-head. The method of producing a magnetic head, in which a magnetic pole of a write-head is constituted by a magnetic film, comprises the steps of: forming a seed layer made of Ru on a surface of a work piece; forming a cap layer on a surface of the seed layer so as to stabilize deposition rate of the magnetic film; and forming the magnetic film by electrolytic plating, and the seed layer and the cap layer are used as power feeding layers for the electrolytic plating.

### BACKGROUND OF THE INVENTION

The present invention relates to a method of producing a magnetic head and a magnetic head, more precisely relates to a method of producing a magnetic head, which is characterized by a process of forming a write-head, and a magnetic head produced by said method.

A conventional perpendicular (vertical) magnetic head is shown in FIG. 7. The perpendicular magnetic head comprises: a read-head 8, in which an MR element 6 for reproducing data is sandwiched between a lower shielding layer 5 and an upper shielding layer 7; and a write-head 10, in which a write-gap 13 is sandwiched between a main magnetic pole 12 and a return yoke 14. A symbol 15 stands for a coil for writing data.

The magnetic pole 12 of the write-head 10 is constituted by a magnetic film. An end face of the magnetic pole 12, which faces a recording medium, is made narrow so as to converge magnetic fluxes and has a film thickness of 3-4 μm. The magnetic pole is formed by plating, so that deposition rate of the magnetic film can be increased and the magnetic film can be selectively plated.

FIGS. 8A-8D show a process of forming the main magnetic pole 12 by plating. Firstly, a seed layer 22 is formed on an upper face of a wafer 20, on which the main magnetic pole 12 of the write-head will be formed, and a resist pattern 24 is formed on a surface of the seed layer 22 (see FIG. 8A). A magnetic film 26, which will become the main magnetic pole 12, is formed by plating (see FIG. 8B). The resist pattern 24 is removed, and the seed layer 22 exposed on the surface of the wafer 20 is etched by a dry process, e.g., ion milling (see FIG. 8C). When the seed layer 22 is etched, some metals 22a, which constitute the seed layer 22, stick onto side faces of the main magnetic pole 12. If the metals 22a stick onto the side faces of the main magnetic pole 12, the main magnetic pole 12 is formed into an undesired shape and a core width must be increased (see FIG. 8D).

The seed layer 22 is made of a nonmagnetic metal, e.g., NiP, NiMo, or a noble metal, e.g., Ru, Pd, Pt. These days, recording densities of recording media are highly increased, so the magnetic pole of the write-head must have enough saturation magnetic flux density (high Bs) and soft magnetic characteristics. Especially, in a perpendicular (vertical) magnetic head which is expected as a next-generation magnetic head, a magnetic pole of a write-head must be made of a material having high Bs and excellent soft magnetic characteristics. For example, Fe-magnetic materials, e.g., FeCo, may be used as high Bs materials. However, soft magnetic characteristics of the Fe-magnetic materials are varied by a type and a crystal structure of a base. Therefore, a material of the base (the seed layer) must be suitably selected so as to gain high Bs and excellent soft magnetic characteristics.

Japanese Patent Gazette No. 2004-127479 discloses a FeCoNi magnetic film, which constitutes a magnetic pole and improves soft magnetic characteristics thereof. Further, Japanese Patent Gazette No. 2005-86012 disclose a plated FeCo thin film, whose crystal structure is oriented to bcc(110).

By using Ru as the seed layer, soft magnetic characteristics of the magnetic pole can be effectively improved. However, Ru is an active metal having various valences and easily form volatile oxides. So, deposition rate of plating is varied at the beginning of deposition of plating, which is reductive reaction of the metal. Namely, the reaction for forming an initial plated layer is influenced by conditions of Ru when the magnetic pole is formed by plating with using Ru as the seed layer, so that the deposition rate of the plating varies.

If the deposition rate varies, amount of deposition is varied. Therefore, thicknesses of magnetic poles (main magnetic poles), which must be precisely controlled to perform high density recording, are varied.

In case of using nonmagnetic materials other than Ru, e.g., NiP, NiMo, as the seed layer, their effects of improving soft magnetic characteristics of the magnetic pole are smaller than that of Ru. Namely, the nonmagnetic materials other than Ru cannot be effectively used as the seed layer. Further, magnetic materials, e.g., NiFe, may be used, instead of Ru, as the seed layer so as to improve soft magnetic characteristics of Fe-plated films. However, if the magnetic material, e.g., NiFe, is used as the seed layer, the magnetic material sticks onto side faces of the magnetic pole when the seed layer is removed by a dry process after forming the magnetic pole by plating. Therefore, the seed layer made of the nonmagnetic material is suitable for easily processing the magnetic pole and improving accuracy of a core-width of a magnetic pole core.

### SUMMARY OF THE INVENTION

The present invention was conceived to solve the above described problems of the conventional technology.

An object of the present invention is to provide a method of producing a magnetic head, which is capable of stabilizing deposition rate of a plated magnetic film forming a magnetic pole of a write-head so as to prevent production accuracy of the magnetic pole, improve soft magnetic characteristics thereof and perform high density recording.

Another object is to provide a magnetic head having a write-head capable of performing high density recording.

To achieve the objects, the present invention has following structures.

Namely, the method of producing a magnetic head, in which a magnetic pole of a write-head is constituted by a magnetic film, comprises the steps of: forming a seed layer made of Ru on a surface of a work piece; forming a cap layer on a surface of the seed layer so as to stabilize deposition rate of the magnetic film; and forming the magnetic film by electrolytic plating, and the seed layer and the cap layer are used as power feeding layers for the electrolytic plating. Note that, the cap layer stabilizes deposition rate of the magnetic film, and the seed layer made of Ru is a base of the magnetic film so as to maintain function of improving soft magnetic characteristics of the magnetic film made of a high Bs material.

The method may further comprise the steps of: forming a resist pattern on a surface of the cap layer; removing the resist pattern after forming the magnetic film; and removing parts of the seed layer and the cap layer, which are exposed in the surface of the work piece, by etching.

In the method, the cap layer may be made of one electrically conductive substance selected from the group consisting of: NiP; NiMo; NiFe; CoNiFe; FeCo; Cu; FeN; FeCoAlO; PdPtMn; PdMn; PtMn; NiMn; Pd; Pt; Au; and Rh.

In the method, a thickness of the cap layer may be 1-10 nm so as to stably form the magnetic film and improve soft magnetic characteristics thereof.

In the method, the magnetic pole may be made of a magnetic material of FeCo (60≦Fe≦80 at %), CoNiFe (55≦Fe≦80 at %, Ni≦20 at %) or FeNi (75≦Fe wt %). Each of the materials has a Bs value of Bs>2T, so the magnetic head capable of performing high density recording can be produced.

The magnetic head of the present invention comprises a write-head whose magnetic pole is made of a plated magnetic film, and a base of the magnetic pole comprises: a seed layer made of Ru; and a cap layer being formed on a surface of the seed layer so as to stabilize deposition rate of the plated magnetic film.

In the magnetic head, the cap layer may be made of one electrically conductive substance selected from the group consisting of: NiP; NiMo; NiFe; CoNiFe; FeCo; Cu; FeN; FeCoAlO; PdPtMn; PdMn; PtMn; NiMn; Pd; Pt; Au; and Rh.

In the method of the present invention, the cap layer is formed on the surface of the seed layer. Therefore, even if the seed layer made of Ru, which easily varies deposition rate of the magnetic film, is used, the magnetic film can be stably plated and a thickness of the magnetic film can be precisely controlled. By precisely controlling the thickness of the magnetic film, the function of improving soft magnetic characteristics of the magnetic film, which is performed by the base including Ru, can be maintained, accuracy of shaping the magnetic film can be improved, and the magnetic head is capable of performing high density recording. Further, the magnetic head of the present invention is capable of performing high density recording with the magnetic pole, which is highly precisely shaped.

### BRIEF DESCRIPTION OF THE DRAWINGS

Embodiments of the present invention will now be described by way of examples and with reference to the accompanying drawings, in which:

FIGS. 1A-1E are explanation views showing a process of forming a magnetic film of the magnetic head of the present invention;

FIG. 2 is a graph of compositions (compositions of Fe) of plated magnetic films;

FIG. 3 is a graph of deposition rates of plating the magnetic films with respect to time of plasma processing;

FIG. 4 is a graph of inclinations (Hk) of hysteresis curves in directions of difficult axes of the magnetic films with respect to time of the plasma processing;

FIG. 5 is a graph of coercive forces (Hc) in directions of the difficult axes of the magnetic films with respect to time of the plasma processing;

FIG. 5 is a graph of coercive forces (Hc) in directions of easy axes of the magnetic films with respect to time of the plasma processing;

FIG. 7 is a sectional view of the conventional perpendicular magnetic head; and

FIGS. 8A-8D are explanation views showing the process of forming the conventional magnetic head.

### DETAILED DESCRIPTION OF THE EMBODIMENTS

Preferred embodiments of the present invention will now be described in detail with reference to the accompanying drawings.

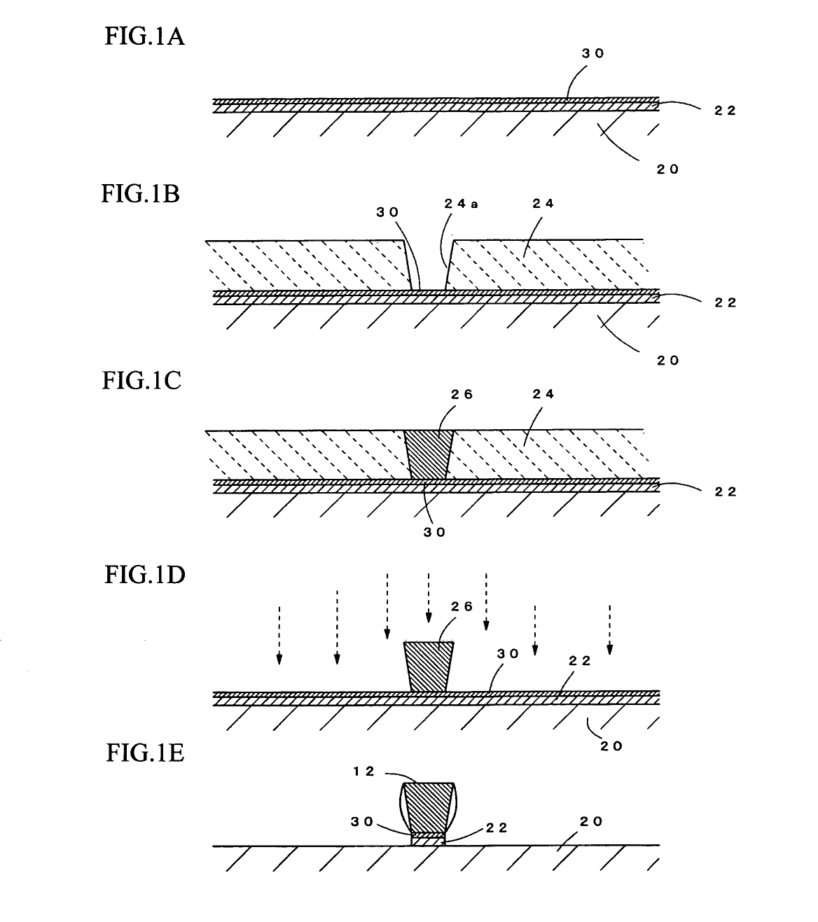

The method of the present invention, in which a magnetic pole of a write-head of a magnetic head, e.g., a main magnetic pole of a perpendicular magnetic head, is formed by plating, is characterized by: using Ru as a seed layer for plating; forming a cap layer, which is made of an electrically conductive material, after forming the Ru seed layer; and forming a magnetic film, which acts as a magnetic pole. Firstly, a production process of the magnetic head of the present invention will be explained with reference to FIGS. 1A-1E.

In FIG. 1A, a seed layer 22 for plating is formed on a surface of a wafer 20, which is a work piece on which films will be formed, so as to form a magnetic film 26, which acts as a magnetic pole, on the work piece 20. Further, a cap layer 30, which is made of an electrically conductive material, is formed on a surface of the seed layer 22.

The seed layer 22 is used as a power feeding layer for forming the magnetic film 26 by electrolytic plating, and it improves soft magnetic characteristics of the magnetic film 26. In the present embodiment, the seed layer 22 is made of Ru. The seed layer 22 may be formed by a proper process, e.g., sputtering, vapor deposition. A thickness of the seed layer 22 is determined on the basis of plating distribution and a step of removing the seed layer 22 after plating. For example, a suitable thickness of the seed layer 22 is about 10-200 nm. In the present embodiment, the thickness of the seed layer 22 is 50 nm.

The cap layer 30 covers the surface of the Ru seed layer 22. In case of solely forming the seed layer 22 for plating, deposition rate varies. Thus, the cap layer 30 restrains the variation of the deposition rate. A material of the cap layer 30 must have enough corrosion-resistance so as not to be corroded by a plating solution, and no tough oxide film must be formed on a surface thereof.

Note that, the cap layer 30 must not block function of the Ru seed layer 22, which improves soft magnetic characteristics of the magnetic pole. To achieve the above described purposes, a thickness of the cap layer 30, which is formed on the surface of the seed layer 22, is properly controlled.

The cap layer 30 is made of an electrically conductive material, which may be a nonmagnetic material or a magnetic material. The cap layer 30 is a very thin film. Even if the seed layer 22 and the cap layer 30 are etched by a dry process, e.g., ion milling, in the following step, little conductive material of the cap layer 30 sticks onto side faces of the magnetic pole so a shape of the magnetic pole is not influenced.

The cap layer 30 may be made of NiP, NiMo, NiFe, CoNiFe, FeCo, Cu, AuFeN, FeCoAlO, PdPtMn, PdMn, PtMn, NiMn, Pd, Pt, Au or Rh. A suitable thickness of the cap layer 30, which is made of the above described substance, is

The cap layer 30 may be formed by proper film forming means, e.g., sputtering, vapor deposition. The means is not limited.

In FIG. 1B, after the seed layer 22 and the cap layer 30 are formed, the surface of the wafer 20 is coated with resist. Then, the resist is patterned on the basis of a planar pattern of the magnetic pole (main magnetic pole) so as to form a resist pattern 24. A groove 24a, in which the cap layer 30 is exposed in an inner bottom face and the magnetic pole will be formed, is formed in the resist by optically exposing and developing the resist in a prescribed pattern.

In FIG. 1C, the magnetic film 26 is formed in the groove 24a by electrolytic plating. In the electrolytic plating, the resist pattern 24 is used as a mask, and the seed layer 22 and the cap layer 30 are used as power feeding layers.

The magnetic film 26 is made of a magnetic material having high saturation magnetic flux density (high Bs). For example, FeCo (60≦Fe≦80 at %), CoNiFe (55≦Fe≦80 at %, Ni≦20 at %) and FeNi (75≦Fe wt %), each of which has a Bs value of Bs>2T, may be used as the suitable magnetic materials of the magnetic film 26. Further, a FeCo multilayered film, in which at least two FeCo layers and magnetic or nonmagnetic layers made of materials other than FeCo are alternately layered, may be used.

In FIG. 1D, the resist pattern 24 is removed after the magnetic pole 26 is formed by plating. By removing the resist pattern 24, the cap layer 30 is exposed in the surface of the wafer 20 other than the part in which the magnetic pole 26 is formed.

In this state, the wafer 20 is ion-milled. By performing the ion milling, the cap layer 30 and the seed layer 22, which is a base of the cap layer 30, other than the parts covered with the magnetic film 26 are removed.

In FIG. 1E, the surface of the wafer 20 is exposed by removing the cap layer 30 and the seed layer 22, and the main magnetic pole 12 is formed. In the process of forming the main magnetic pole 12, the cap layer 30 and the seed layer 22 are used as the base, and the magnetic film 26 is formed by plating.

By etching or ion-milling the exposed parts of the cap layer 30 and the seed layer 22, the conductive material of the cap layer 30 and Ru of the seed layer 22 stick onto side faces of the main magnetic pole 12. However, the cap layer 30 is the very thin film, so the shape of the main magnetic pole 12 is not badly deformed. Further, Ru of the seed layer 22 is a nonmagnetic material, so Ru stuck on the side faces do not magnetically influence the main magnetic pole 12. Namely, an magnetic effective end shape of the main magnetic pole 12 is not badly influenced by the cap layer 30 and the seed layer 22.

In the above described embodiment of the method of producing the magnetic head, when the magnetic film 26 is formed by electrolytic plating, deposition rate of the plated film can be stabilized, and variation of the deposition rate, which is caused by surface conditions of the Ru seed layer 22, can be restrained. Therefore, the main magnetic pole 12 having the prescribed thickness and the prescribed end shape can be securely produced.

In case of forming the magnetic film of the magnetic pole by plating, the above described method, which is capable of stabilizing the deposition rate of the magnetic film and precisely forming the magnetic pole, can be effectively used to produce the perpendicular magnetic head used for high density recording.

### EXAMPLES OF EXPERIMENTS

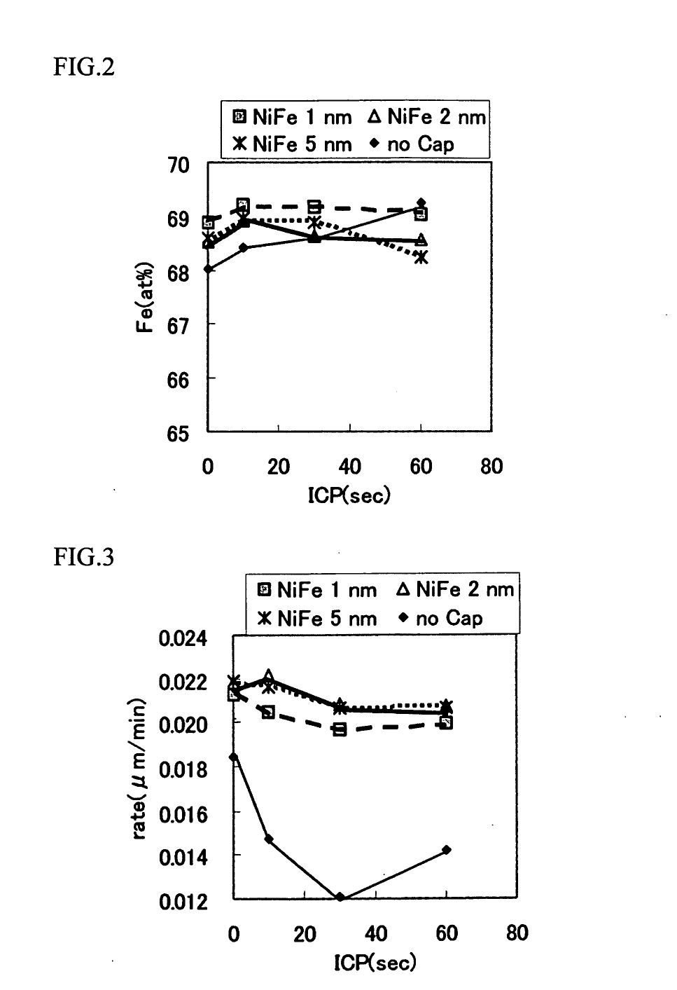

Characteristics of plated magnetic films (samples) were examined, and the results are shown in FIGS. 2 and 3. One of the samples had no cap layer; the rest samples had the cap layers 30 made of NiFe, and the thicknesses of the NiFe layers were 1 nm, 2 nm and 5 nm. In each of the samples, the thickness of the Ru seed layer 22 was 50 nm, and the magnetic film 26 of Fe70Co30 was formed by plating. As described above, the thickness of the seed layer 22 is determined on the basis of plating distribution and the step of removing the seed layer 22 after plating. The suitable thickness of the Ru layer is about 10-200 nm.

In the experiment whose results are shown in FIGS. 2 and 3, the cap layer 30 of each sample was formed by sputtering, the resist pattern 24 is formed, then O₂-plasma processing (ICP) was applied so as to improve wetness of the plated film. In FIGS. 2 and 3, horizontal axes of the graphs are time of the plasma processing.

Note that, sulfate test reagents of Co and Fe were used as a plating solution so as to supply Co ions and Fe ions. Further, boric acid, sodium chloride (a conductive agent) and saccharin sodium (a stress relaxation agent) were added. The plating was performed in a DC magnetic field of about 64 KA/m. pH value of the solution was 2.0-3.0. Pulse current, whose average current density was 3-25 mA/cm², duty cycle was 5-75% and frequency was 1-100 Hz, was applied to the solution. Temperature of the solution was 20-35° C.

Firstly, a relationship between existence of the cap layers 30 and variations of composition of the magnetic films 26 was examined. According to FIG. 2, the compositions of the plated magnetic films 26 were not influenced by existence and thickness of the cap layers 30. Further, the compositions of the magnetic films 26 were not substantially influenced by the time of the plasma processing.

Next, a relationship between deposition rates of the magnetic films 26 and the time of the plasma processing was examined, and unique results were gained. According to FIG. 3, the deposition rate of the magnetic film 26 having no cap layer was extremely varied by the time of the plasma processing. Namely, the deposition rate of the magnetic film 26 was reduced with extending the time of the plasma processing. The inventor thinks that Ru is easily oxidized, and the surface condition of the seed layer 22 was highly changed so that the deposition rate was extremely varied.

On the other hand, in the samples having the NiFe cap layers 30, the deposition rates were slightly reduced with extending the time of the plasma processing. In comparison with the sample having no cap layer, the deposition rates of the samples having the cap layers 30 were highly stabilized. Namely, the seed layers 22 were stabilized by providing the cap layers 30. The deposition rates of the samples having the NiFe cap layers 30, whose thicknesses were 1 nm, 2 nm and 5 nm, were improved, so the variation of the deposition rates can be restrained by the cap layer 30 whose thickness was 1 nm or more.

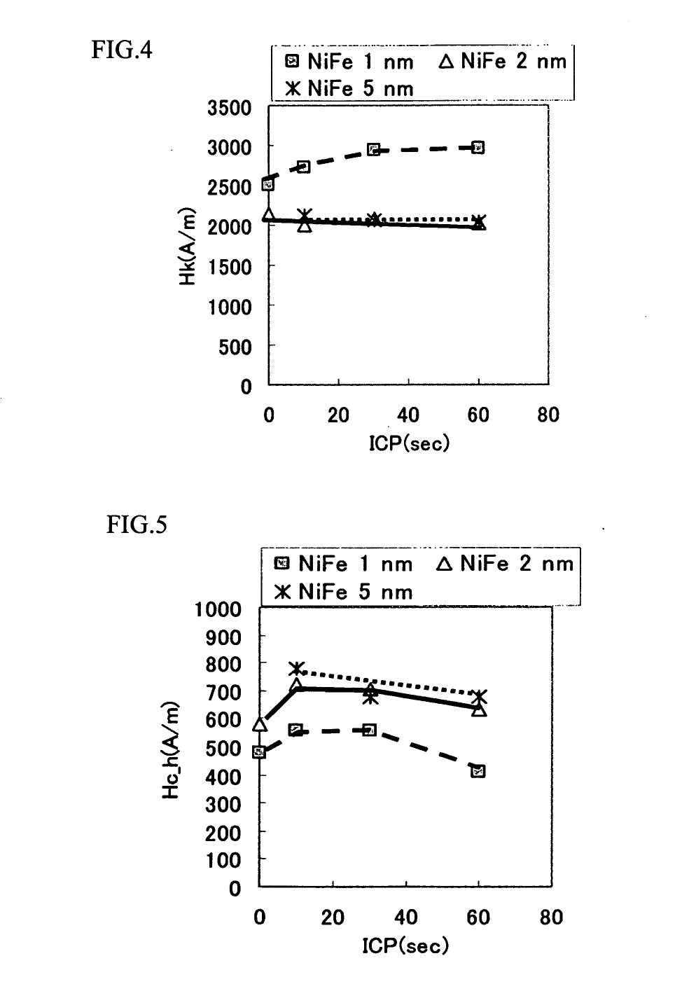

Further, the inventor examined a relationship between magnetic characteristics of the magnetic films and the time of the plasma processing. The results are shown in FIGS. 4-6. Samples of the experiments have the NiFe cap layers 30, which respectively have thicknesses of 1 nm, 2 nm and 5 nm.

FIG. 4 is a graph of inclinations (Hk) of hysteresis curves in directions of difficult axes of the samples. According to the graph, the Hk values were slightly varied by the thicknesses of the cap layers 30, but they were not extremely varied by the time of the plasma processing.

FIG. 5 is a graph of coercive forces in the directions of the difficult axes; FIG. 6 is a graph of coercive forced in directions of easy axes. According to FIG. 5, the coercive forces were slightly varied by the thicknesses of the cap layers 30, but they were not extremely varied by the time of the plasma processing.

Therefore, the cap layers 30 stabilized the deposition rates of the plated films and magnetic characteristics thereof.

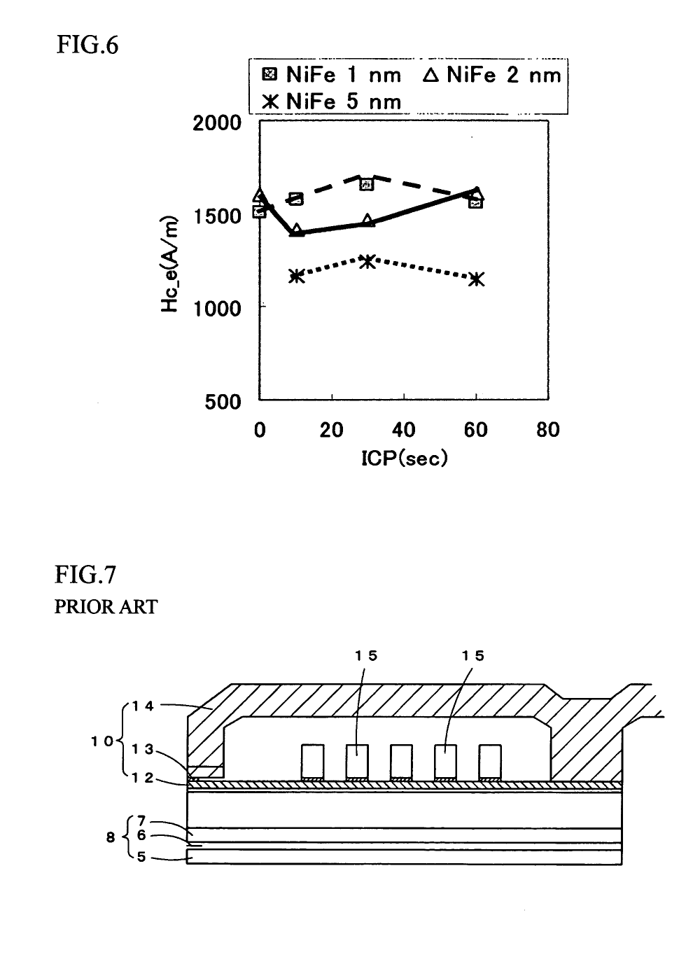

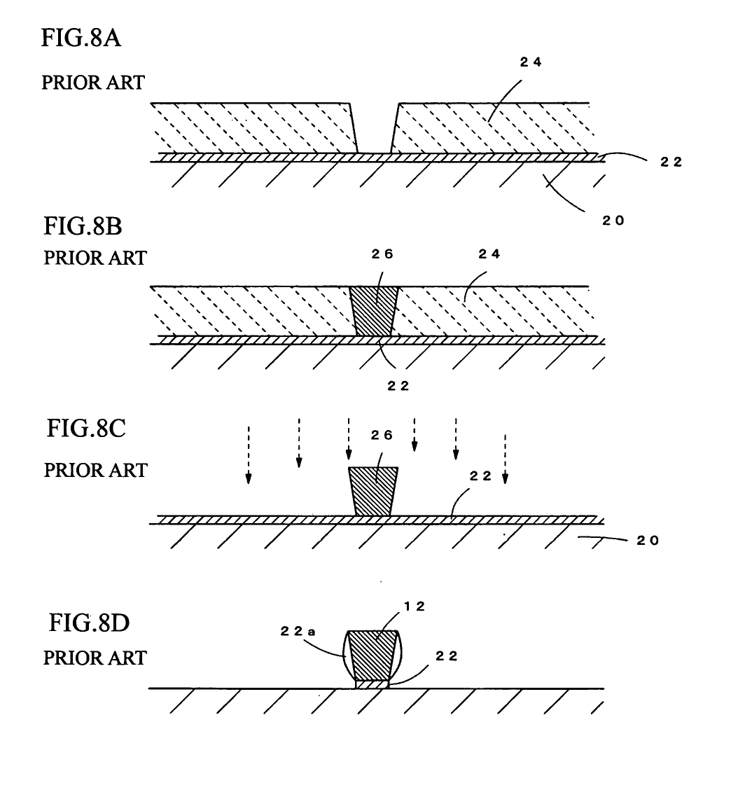

In the method of the present invention, the magnetic film, which constitutes the magnetic pole, can be stably formed when the magnetic film is plated with using the Ru seed layer. Therefore, the method can be suitably used to form the main magnetic pole 12 of the perpendicular magnetic head (see FIG. 7) by plating. The main magnetic pole 12 must have high Bs and excellent soft magnetic characteristics. By using the Ru seed layer 22, the magnetic film of the main magnetic pole 12 can be properly made of the high Bs material, e.g., FeCo, and can improve soft magnetic characteristics of the main magnetic pole 12. Further, by providing the cap layer 30, the thickness of the magnetic film of the main magnetic pole 12 and the shape of the main magnetic pole 12 can be precisely controlled.

Note that, the present invention can be applied to not only the main magnetic pole of the write-head of the perpendicular magnetic head but also a pole end of a lower magnetic pole of a write-head of a horizontal magnetic head. Further, the present invention can be used to form an upper magnetic pole, which is constituted by a plated magnetic film.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A method of producing a magnetic head, in which a magnetic pole of a write-head is constituted by a magnetic film,
comprising the steps of:
forming a seed layer made of Ru on a surface of a work piece;
forming a cap layer on a surface of said seed layer so as to stabilize deposition rate of said magnetic film; and
forming said magnetic film by electrolytic plating,
wherein said seed layer and said cap layer are used as power feeding layers for the electrolytic plating.

2. The method according to claim 1,
further comprising the steps of:
forming a resist pattern on a surface of said cap layer;
removing said resist pattern after forming said magnetic film; and
removing parts of said seed layer and said cap layer, which are exposed in the surface of the work piece, by etching.

3. The method according to claim 1,
wherein said cap layer is made of one electrically conductive substance selected from the group consisting of: NiP; NiMo; NiFe; CoNiFe; FeCo; Cu; FeN; FeCoAlO; PdPtMn; PdMn; PtMn; NiMn; Pd; Pt; Au; and Rh.

4. The method according to claim 3,
wherein a thickness of said cap layer is 1-10 nm.

5. The method according to claim 1,
wherein the magnetic pole is made of a magnetic material of FeCo (60≦Fe≦80 at %).

6. The method according to claim 1,
wherein the magnetic pole is made of a magnetic material of CoNiFe (55≦Fe≦80 at %, Ni≦20 at %).

7. The method according to claim 1,
wherein the magnetic pole is made of a magnetic material of FeNi (75≦Fe wt %).

8. A magnetic head,
comprising:
a write-head whose magnetic pole is made of a plated magnetic film,
wherein a base of the magnetic pole comprises:
a seed layer made of Ru; and
a cap layer being formed on a surface of said seed layer so as to stabilize deposition rate of the plated magnetic film.

9. The magnetic head according to claim 8,
wherein said cap layer is made of one electrically conductive substance selected from the group consisting of: NiP; NiMo; NiFe; CoNiFe; FeCo; Cu; FeN; FeCoAlO; PdPtMn; PdMn; PtMn; NiMn; Pd; Pt; Au; and Rh.
